(19) United States
(12) Patent Application Publication
(10) Pub. No.: US 2006/0004932 A1
(43) Pub. Date: Jan. 5, 2006

(54) Multi-directional data transfer using a single DMA channel

(76) Inventor: Russell Coleman Deans, Durham, NC (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/171,192

(22) Filed: Jul. 1, 2005

Related U.S. Application Data
(60) Provisional application No. 60/585,178, filed on Jul. 2, 2004.

(51) Int. Cl. G06F 13/28

(52) U.S. Cl. 710/22

(57) ABSTRACT

A single direct memory access (DMA) channel provides bi-directional transfer of data between two devices by selectively swapping the source and destination registers of the DMA channel in response to a binary control signal. The source of the control signal can be one of the devices involved in the data transfer, e.g. an I/O device. When the control signal is in one state, the DMA channel operates in the normal manner to read data from the address stored in the source register and write the data to the address stored in the destination register. When the signal is in the opposite state, the DMA channel reads the data from the address stored in the destination register, and writes it to the address stored in the source register. This change in the direction of data transfer can be accomplished without any input from the CPU.

This disclosure is based upon Provisional Application No. 60/585,178, filed Jul. 2, 2004, the contents of which are incorporated herein by reference.

### FIELD OF THE INVENTION

The present invention is directed to the transfer of data from one device to another, and more particularly the transfer of data by means of direct memory access.

### BACKGROUND OF THE INVENTION

Direct memory access (DMA) is used in a variety of applications to transfer data between a microprocessor and an input/output (I/O) device. For instance, Management Data Input/Output (MDIO) is a serial interface that enables an external MDIO master (Station Management Entity or “STA”) to access registers in devices on fiber-optic transceiver modules, such as XENPAK or XPAK modules which conform to the 10 Gigabit Ethernet (10 GbE) standard. One of the devices being accessed can be a microcontroller that uses memory to emulate these registers. The microcontroller can employ various methods to move the data between the memory and the MDIO serial interface.

One method can be to use the microcontroller's central processing unit (CPU) to do the transfers. This may not be a practical solution in an 8 or 16-bit, medium speed (e.g., about 10 MHz) microcontroller, as the time between receiving a request for data from the MDIO master and sending the data to the MDIO master can be too short. For example, assuming the MDIO interface is running at its maximum rate of 2.5 MHz, only about 40 10 MHz CPU cycles are available. A second method can be to directly connect the MDIO and memory blocks by using either a dual-port memory or some type of a memory management unit. This option can be fast enough, but can achieve this speed at the expense of increased block size and complexity. A third, and more preferred, method is to employ DMA.

In a microcontroller having a limited number of basic direct memory access control (DMAC) channels, to perform a direct memory access data transfer from a first location, A, to a second location, B, and from location B to location A, without any intervention by a CPU, requires two DMA channels. Each DMA channel includes a source register that stores the address from which the data is read, and a destination register that stores the address to which the data is written. Hence, a separate channel is needed for each different source-destination pair.

It is desirable to use only one DMA channel for transfers in both directions, so the second channel can be used for other data transfer tasks. It is possible to accomplish such a result by having the CPU reconfigure the registers of a given DMA channel before or after each data transfer, but such a procedure is contrary to the fundamental purpose of DMA data transfers, namely to relieve the CPU of the burden of the detailed operations associated with data transfers.

### SUMMARY OF THE INVENTION

In accordance with the present invention, this objective is achieved by selectively swapping the source and destination registers of a DMA channel in response to a binary control signal. The source of the control signal can be one of the devices involved in the data transfer, e.g. an I/O device. When the control signal is in one state, the DMA channel operates in the normal manner to read data from the address stored in the source register and write the data to the address stored in the destination register. When the signal is in the opposite state, the DMA channel reads the data from the address stored in the destination register, and writes it to the address stored in the source register. This change in the direction of data transfer can be accomplished without any input from the CPU.

Further features of the invention, and the advantages achieved thereby, are described hereinafter with reference to exemplary embodiments illustrated in the accompanying figures.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements.

FIG. 1 is a block diagram of a basic DMA system that implements the principles of the present invention;

FIG. 2 is a block diagram of one embodiment for swapping source and destination registers; and

FIG. 3 is a block diagram of a DMA system that employs a variable data access address.

### DETAILED DESCRIPTION

Various aspects of the invention will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both.

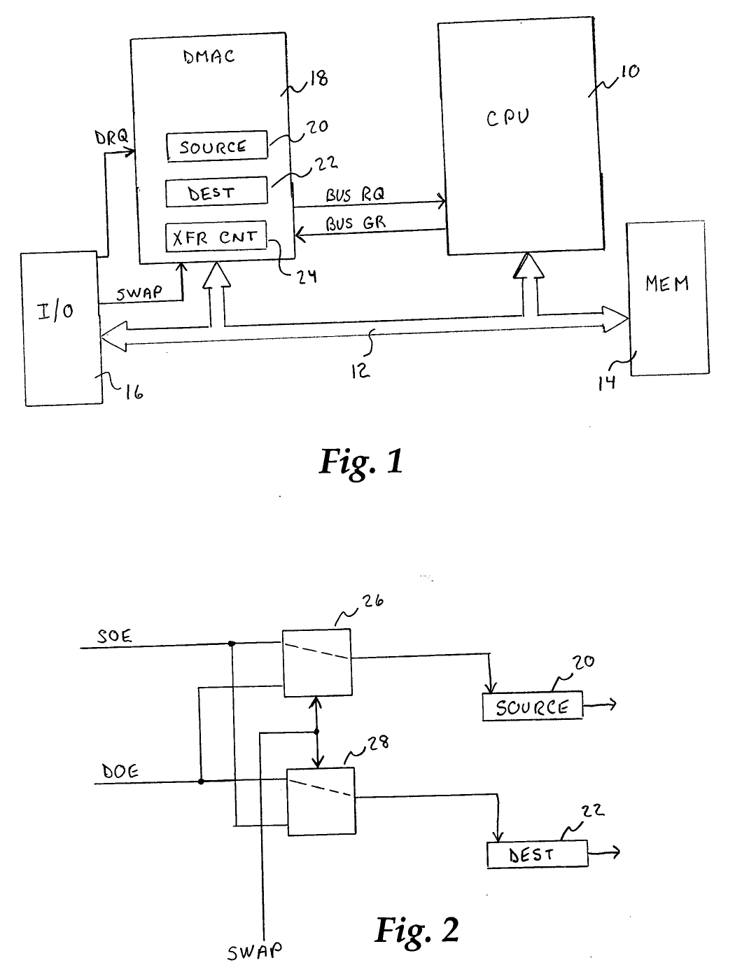

The basic structure of a system that utilizes direct memory access to transfer data from one location to another is illustrated in FIG. 1. The system includes a CPU 10 that is connected to a bus 12. The bus serves as the path via which data is transferred between a memory structure 14 and an I/O device 16, under command of the CPU. The memory structure 14 could be any of a variety of memory devices that is used to store data within the system, such as the internal working RAM of the CPU, a frame buffer in a video card, a hard disk, etc.

Also connected to the bus 12 is a direct memory access controller (DMAC) 18. The DMAC 18 can support a number of channels to provide for the transfer of data between different combinations of devices. For each channel, the DMAC includes a source register 20, a destination register 22 and a transfer count register 24. For illustrative purposes, only a single channel is represented in the example of FIG. 1. The source register 20 contains the address where the data to be transferred is currently stored, e.g. an address associated with the I/O device 16. The destination register contains the address to which the data is to be transferred, e.g. an address in the memory 14. The transfer count register 24 stores the number of transfers remaining. Typically, the contents of the registers are loaded by the CPU 10.

In operation, when data is to be transferred from one location to another, e.g. from the I/O device 16 to the memory 14, the I/O device asserts a DMA request signal DRQ. In response to this signal, the DMAC requests control of the bus 12 from the CPU. When the bus request is granted and the DMAC acquires control of the bus, it places the address in the source register 20 on the bus and reads a block of data from the I/O device 16. The DMAC then places the address in the destination register 22 on the bus and writes the block of data to that address. If the transfer involves multiple blocks of data, the addresses in the registers 20 and 22 are incremented, and the cycle is repeated. After each block is transferred, the value in the transfer count register 24 is decremented, until it reaches zero.

If data is to be transferred in the opposite direction, i.e. from the memory 14 to the I/O device 16, a second DMA channel was conventionally employed. This additional channel required a second set of registers 20-24, in which an address associated with the memory 14 was stored in the source register, and an address associated with the I/O device was stored in the destination register.

The present invention provides an arrangement via which the same DMA channel can be employed to transfer data in both directions, without requiring the CPU to load new values in the source and destination registers. This feature is accomplished by making the source and destination registers swappable, i.e. to enable each register to function selectively as the source or destination register. As a result, the contents of the registers do not have to be reloaded when the direction of the data transfer changes.

One embodiment for implementing this feature is illustrated in FIG. 2. When the DMAC drives the source address onto the bus 12, it issues a source_output_enable signal SOE that is applied to the source register 20 to enable its contents to be loaded onto the bus. Similarly, when the destination address is to be driven onto the bus, the DMAC issues a destination_output_enable signal DOE that is applied to the destination register 22. To enable the source and destination registers to be swappable, a pair of selectors 26 and 28 are used to direct the SOE and DOE signals to the source register 20 and the destination register 22, respectively, or vice versa. The selective swapping of the registers is carried out in response to the state of a binary SWAP signal. When the SWAP signal is in one binary state, e.g. low, the selector 26 connects the SOE signal to the source register 20, and the selector 28 connects the DOE signal to the destination register 22, as depicted by the dotted lines in FIG. 2. In this state, the DMA channel operates in the normal manner, e.g. to transfer data from the I/O device 16 to the memory 14.

When the SWAP signal is in the other state, e.g. high, the selectors toggle so that the SOE signal is applied to the destination register 22 and the DOE signal is applied to the source register 20. In this state, when the DMAC issues the SOE signal, the address in the destination register 22 is driven onto the bus, to identify the address from which the data is to be read. Subsequently, when the DOE signal is issued, the address in the source register 20 is driven onto the bus to indicate the address to which the data is to be written. Thus, the data transfer occurs in the opposite direction, e.g. from the memory 14 to the I/O device 16.

The SWAP signal can be generated by any of a variety of sources. For instance, it can be a form of command issued by the CPU. Preferably, however, the SWAP signal is generated by one of the devices involved in the data transfer. For instance, in the situation where the I/O device 16 issues the DMA request signal DRQ, it can also generate the SWAP signal at the same time, as depicted in FIG. 1. When the I/O device has data to be provided to another device, the SWAP signal can be low, and when the I/O device needs to acquire data, the SWAP signal can be high.

While two individual selectors are depicted in the embodiment of FIG. 2, it will be appreciated that the swapping of the enable signals can be accomplished with any suitable structure that is capable of selectively directing two input signals to either of two output ports, such as a multiplexer.

A typical case where the arrangement of FIG. 1 can be employed is in the transfer of data between a peripheral having a fixed data access address and another similar peripheral. In this case, a single DMA channel can be used to transfer data in both directions between the two peripherals. Swappable source and destination registers can also be used when data is transferred between such a peripheral and a memory device having variable addresses (such as RAM). Typically, two DMA channels are used for each direction of transfer. One channel is used to perform the actual data transfer, and the other channel is used to load the variable address into the source register of the first channel. Thus, to perform bi-directional transfers, four DMA channels were required with a conventional configuration. By employing swappable registers in accordance with the present invention, however, the number of required channels can be reduced from four to two.

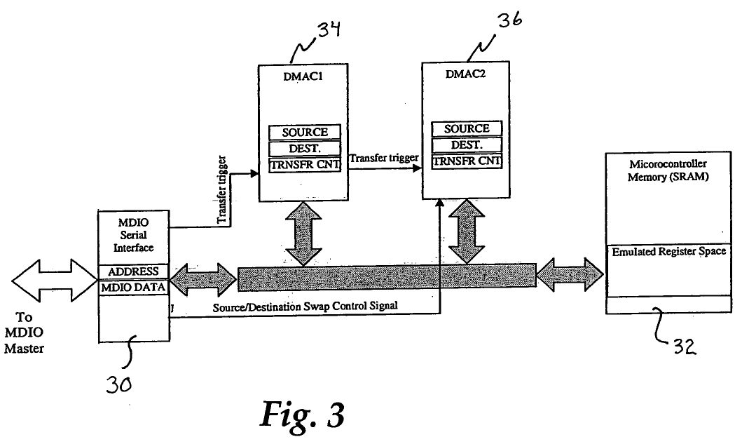

One example of this latter application of the invention is depicted in FIG. 3. In this example, a serial interface 30 exchanges data with the addressable memory 32, e.g. RAM, of a microcontroller. For instance, the interface 30 can be associated with an external MDIO master (not shown) that accesses registers in transceiver modules. The microcontroller might emulate these registers in its memory 32. A pair of DMACs 34 and 36 control the transfer of data between the serial interface 30 and the memory 32.

In operation, the first DMAC 34 can be triggered when the MDIO master requests data or when data from the MDIO master is received. Once triggered, the first DMAC 34 can read the address output from the MDIO serial interface 30 and write the address to the source register of the second DMAC 36. The serial interface 30 can then trigger the second DMAC 36 to perform the actual data transfer, e.g. from the memory 32 to the serial interface 30. If the direction of data transfer is to go from the serial interface 30 to the memory 32, a swap signal generated in the serial interface is activated and applied to the second DMAC 36, causing the source and destination registers of the second DMAC 36 to be swapped. This allows two DMA channels to support transfers in both directions, in contrast to the four DMA channels that would be conventionally employed. This approach does not appreciably increase block size or complexity.

From the foregoing, it can be seen that the present invention enables the source and destination registers of a DMA channel to be swapped, so that bi-directional data transfers between two devices can be accomplished via a single channel. As a result, other channels can be used to perform additional DMA tasks. In effect, the data transfer capabilities of a DMA controller can be doubled without increasing the number of channels that it supports.

It will be appreciated by those of ordinary skill in the art that the concepts and techniques described here can be embodied in various specific forms without departing from the essential characteristics thereof. The presently disclosed embodiments are considered in all respects to be illustrative and not restrictive.

What is claimed is:

1. A direct memory access channel for transferring data from a first device to a second device, comprising:
a source register that stores a memory address associated with one of the devices;
a destination register that stores a memory address associated with the other of the devices;
a controller that generates source and destination register enable signals to place the addresses stored in said registers on a bus; and
a swap circuit that is responsive to a first state of a control signal to cause said source register enable signal to place the contents of said source register on the bus and to cause said destination register enable signal to place the contents of said destination register on the bus, and is responsive to a second state of the control signal to cause said source register enable signal to place the contents of said destination register on the bus and to cause said destination register enable signal to place the contents of said source register on the bus.

2. The direct memory access channel of claim 1 wherein said control signal is generated by a device that is external to said channel.

3. The direct memory access channel of claim 2 wherein said external device is one of said first and second devices between which the data is transferred.

4. The direct memory access channel of claim 1 wherein said swap circuit comprises at least one selector that directs said source register enable signal to said source register and directs said destination register enable signal to said destination register, or vice versa, in accordance with the state of said control signal.

5. The direct memory access channel of claim 1, wherein the address associated with at least one of said first and second devices is variable, and further including a second direct memory access channel that is responsive to a request to transfer data to load said variable address into one of said registers.

6. A system for bidirectionally transferring data between a first device and a second device, comprising:
a direct memory access channel having a pair of registers that store addresses associated with said devices that respectively identify the source and destination of data to be transferred; and
means responsive to a control signal having at least two states for designating one of said registers as the identifier of the data source and the other register as the identifier of the data destination, and vice versa, in accordance with the state of the control signal.

7. The system of claim 6 wherein said direct memory access channel includes a controller that generates a pair of enable signals that cause the addresses stored in said registers, respectively, to be placed on a bus, and said designating means comprises a selector that directs each of said enable signals to one or the other of said registers in accordance with the state of the control signal.

8. The system of claim 7 wherein said control signal is generated by a device that is external to said controller.

9. The system of claim 8 wherein said external device is one of said first and second devices between which the data is transferred.

10. The system of claim 6, wherein the address associated with at least one of said first and second devices is variable, and further including a second direct memory access channel that is responsive to a request to transfer data to load said variable address into one of said registers.

11. A method for bidirectionally transferring data between first and second devices via a direct memory access channel, comprising the following steps:
storing an address associated with one of said devices in a first register of said channel and storing an address associated with the other device in a second register of said channel;
designating the address stored in said first register as the source of data to be transferred and designating the address stored in said second register as the destination for data to be transferred;
in response to a control signal, swapping the designations of said registers so that the address stored in the first register becomes the destination for the data and the address stored in the second register becomes the source of the data to be transferred; and
transferring data from the address in the register designated as the source to the address in the register designated as the destination via said direct memory access channel.

12. The method of claim 11, wherein the addresses stored in said registers are fixed addresses respectively associated with said first and second devices.

13. The method of claim 11, wherein at least one of said devices has a variable address associated with it, and further including the step of loading the variable address into one of said registers via another direct memory access channel, in response to a request to transfer data.

14. The method of claim 11 wherein said control signal is generated by a device that is external to said channel.

15. The method of claim 14 wherein said external device is one of said first and second devices between which the data is transferred.
